(19) United States
(12) Patent Application Publication
(10) Pub. No.: US 2026/0028233 A1
(43) Pub. Date: Jan. 29, 2026

(54) POROUS CARBON MATERIAL AND PREPARATION METHOD THEREOF, SILICON-CARBON MATERIAL, SECONDARY BATTERY, AND ELECTRONIC DEVICE

(71) Applicant: Ningde Amperex Technology Limited, Ningde (CN)

(72) Inventors: Xianghuan LIU, Ningde (CN); Yisong SU, Ningde (CN); Hang CUI, Ningde (CN); Yuansen XIE, Ningde (CN)

(73) Assignee: Ningde Amperex Technology Limited, Ningde (CN)

(21) Appl. No.: 19/279,083

(22) Filed: Jul. 24, 2025

(30) Foreign Application Priority Data
Jul. 24, 2024 (CN) 202411001979.4

(51) Int. Cl. C01B 32/956

(52) U.S. Cl. CPC C01B 32/956; C01P 2002/72; C01P 2002/82; C01P 2004/03; C01P 2004/61; C01P 2006/10; C01P 2006/12; C01P 2006/14; C01P 2006/16

(57) ABSTRACT

A porous carbon material having, based on a pore volume of the porous carbon material, a volume proportion of ultramicropores with a pore diameter less than or equal to 0.7 nm is denoted as P₀%, and a volume proportion of micropores with a pore diameter less than or equal to 2 nm is denoted as P₁%, where 2≤P₀≤28 and 92≤P₁≤100.

### CROSS-REFERENCE TO RELATED APPLICATION

This application claims priority from Chinese Patent Application No. 202411001979.4, filed on Jul. 24, 2024, the contents of which are incorporated herein by reference in its entirety.

### TECHNICAL FIELD

This application pertains to the field of energy storage technologies, and specifically relates to a porous carbon material and a preparation method thereof, a silicon-carbon material, a secondary battery, and an electronic device.

### BACKGROUND

Silicon-carbon materials, including elements silicon and carbon, combine the advantages of high capacity and stability, demonstrating significant potential in negative electrode materials for secondary batteries, particularly in secondary batteries such as lithium-ion batteries and sodium-ion batteries.

However, silicon undergoes significant volume expansion and contraction during charging and discharging, which can easily lead to structural damage in silicon-carbon materials, resulting in issues such as surface peeling and particle pulverization. This causes silicon-carbon materials to undergo side reactions with electrolytes during charge-discharge cycles, leading to the loss of active materials and further exacerbating cycling performance degradation, thereby reducing the performance of secondary batteries. Therefore, how the structure of silicon-carbon materials is optimized to improve cycling stability of secondary batteries has become an urgent issue to be addressed in this field.

### SUMMARY

To address the above issue, this application provides a porous carbon material and a preparation method thereof, a silicon-carbon material, a secondary battery, and an electronic device. By means of controlling a proportion of micropores in the porous carbon material to improve its internal compactness, structural stability and compressive strength of the porous carbon material can be improved. This can slow down the expansion rate of the silicon-carbon material during cycling while increasing the surface area of the porous carbon material and promoting the intercalation and deintercalation of active materials, thereby improving the expansion suppression performance, cycling performance, and rate performance of the secondary battery.

According to a first aspect, this application provides a porous carbon material, where based on a pore volume of the porous carbon material, a volume proportion of ultramicropores with a pore diameter less than or equal to 0.7 nm is denoted as P₀%, and a volume proportion of micropores with a pore diameter less than or equal to 2 nm is denoted as P₁%, where 2≤P₀≤28 and 92≤P₁≤100. By controlling the volume proportions of ultramicropores and micropores in the porous carbon material, this application can promote uniform silicon deposition while providing space for silicon deposition. Additionally, this allows for a highly compact cross-linked structure within the porous carbon material, which can enhance the structural stability and compressive strength of the material, and provide stable support for silicon materials, thereby better buffering the volume changes and stresses of silicon during charging and discharging. This reduces structural damage to the silicon materials caused by volume expansion or contraction during charging and discharging, and improves the expansion suppression performance and cycling performance of the secondary battery. Furthermore, the above micropore structure can increase the surface area of the porous carbon material, promote the intercalation and deintercalation of active materials, and in conjunction with the conductive network formed by the cross-linked structure, enhance the rate performance of the secondary battery.

In some more preferred embodiments, 6.5≤P₀≤19.5 and 95≤P₁≤100. The volume proportions of ultramicropores and micropores in the porous carbon material are adjusted to meet these conditions. A relatively high proportion of micropores can further enhance the deposition uniformity of silicon and the structural stability of the porous carbon material, improving the expansion suppression performance and cycling performance of the secondary battery. In combination with the volume proportion of ultramicropores, the rate performance of the secondary battery can be significantly enhanced.

In some embodiments, a specific surface area of the porous carbon material is denoted as SA m²/g, where 1059≤SA≤2486; and/or a pore volume of the porous carbon material is denoted as Pv cm³/g, where 0.52≤Pv≤1.6. In this application, the specific surface area and pore volume of the porous carbon material are regulated to meet the above ranges, to allow a large specific surface area and abundant micropore structure for the porous carbon material, enhancing the adsorption capacity for silane gas, and achieving higher silicon deposition amount. This can also improve the mechanical strength and structural stability of the porous carbon material, to obtain a silicon-carbon material with high energy density and structural stability, enabling the secondary battery to have high energy density while maintaining excellent rate performance, expansion suppression performance, and cycling performance.

In some embodiments, a compressive strength of the porous carbon material is denoted as CS MPa, where 161≤CS≤1968; preferably, 1096≤CS≤1878. The porous carbon material with high compressive strength provided in this application can be used as a matrix to prepare silicon-carbon negative electrode materials with high compressive strength. Enhancing the strength of the porous carbon matrix can improve the strength of the silicon-carbon material, and reduce breakage of silicon-carbon particles during the rolling process of electrode plate preparation. This helps maintain high initial Coulombic efficiency and energy density, and also improves the expansion suppression performance and cycling performance of the secondary battery.

In some embodiments, the porous carbon material satisfies at least one of the following conditions: (1) an average ellipticity of the porous carbon material is denoted as ERm, where 0.91≤ERm≤1; (2) a particle size Dᵥ50 of the porous carbon material is denoted as D μm, where 5.2≤D≤9.8; (3) a compacted density of the porous carbon material under a force of 5000 kgf is denoted as ρ g/cm³, where 0.45≤ρ≤0.7; or (4) in a Raman spectrum of the porous carbon material, 0.8≤ID/IG≤1.5. With the porous carbon material adjusted to satisfy at least one of the above conditions, together with the ultramicropore and micropore structures, the rate performance, expansion suppression performance, and cycling performance of the secondary battery can be further improved.

According to a second aspect, this application provides a preparation method of the porous carbon material according to any one of the above embodiments, including the following steps: step 1. subjecting a phenolic compound, an acidic catalyst, a stabilizer, and an aldehyde compound to gradient heat preservation treatment under an inert atmosphere to obtain an organic precursor, where the gradient heat preservation treatment includes performing a first heat preservation treatment at a first temperature T₁° C. for a heat preservation duration of t₁ h, and then performing a second heat preservation treatment at a second temperature T₂° C. for a heat preservation duration of t₂ h, where 20≤T₁≤100; 0.5≤t₁≤6; 60≤T₂≤150; and 0.5≤t₂≤16; and a mass ratio of the phenolic compound, the acidic catalyst, and the aldehyde compound is 1:(1-5):(2-5); step 2. sequentially subjecting the organic precursor to curing treatment and carbonization treatment to obtain a carbide; and step 3. mixing the carbide with an activator, followed by activation treatment to obtain the porous carbon material, where the activator includes potassium hydroxide and sodium carbonate, a mass ratio of the potassium hydroxide to the sodium carbonate being 1:(0.1-0.3); and the activation treatment is performed at a temperature T₅° C. for a duration of t₅ h, where 621≤T₅≤854; and 0.5≤t₅≤6. By controlling the ratio of the raw materials and catalysts in conjunction with gradient heat preservation treatment and controlling the activation treatment conditions to meet the above ranges, this application can enhance the cross-linking degree of the organic precursor, increase the micropore volume proportion of the porous carbon material, and create a highly compact cross-linked structure within the porous carbon material, improving the rate performance, expansion suppression performance, and cycling performance of the secondary battery when applied in the secondary battery.

In some embodiments, the preparation method satisfies at least one of the following conditions: (1) the phenolic compound includes at least one of phenol, resorcinol, phloroglucinol, or bisphenol A; (2) the acidic catalyst includes at least one of hydrochloric acid, sulfuric acid, nitric acid, or oxalic acid; (3) the aldehyde compound includes at least one of formaldehyde, paraformaldehyde, furfural, or acetaldehyde; (4) the stabilizer includes at least one of polyvinyl alcohol, polyethylene glycol, hydroxymethyl cellulose, carboxymethyl cellulose, or polyvinylpyrrolidone; (5) a mass ratio of the phenolic compound to the stabilizer is 1:(0.01-2.8); (6) the curing treatment is performed at a temperature T₃° C. for a duration of t₃ h; where 40≤T₃≤120; and 0.5≤t₃≤6; (7) the carbonization treatment is performed at a temperature T₄° C. for a duration of t₄ h; where 500≤T₄≤1000; and 0.5≤t₄≤6; or (8) a mass ratio of the carbide to the activator is denoted as w, where 0.1≤w≤1. By adjusting the preparation method to satisfy at least one of the above conditions, this application can further optimize the micropore structure of the porous carbon material, improving the rate performance, expansion suppression performance, and cycling performance of the secondary battery.

According to a third aspect, this application provides a silicon-carbon material including the porous carbon material provided in the first aspect or the porous carbon material obtained using the preparation method provided in the second aspect. Regulating the ultramicropore and micropore structures of the porous carbon can enhance the conductivity and structural stability of the carbon matrix in the silicon-carbon material, thereby reducing the resistance and volume expansion of the silicon-carbon material during charging and discharging, and improving the rate performance, expansion suppression performance, and cycling performance of the secondary battery.

According to a fourth aspect, this application provides a secondary battery including a positive electrode, a negative electrode, and an electrolyte, where the negative electrode includes a negative electrode current collector and a negative electrode active material layer disposed on at least one surface of the negative electrode current collector; and the negative electrode active material layer includes the silicon-carbon material provided in the third aspect.

According to a fifth aspect, this application provides an electronic device including the secondary battery provided in the fourth aspect.

Based on the porous carbon material and preparation method thereof, silicon-carbon material, secondary battery, and electronic device provided in this application, this application enhances the structural stability and adsorption capacity for silane gas by improving the ultramicropore and micropore structures of the porous carbon material. The high-compressive-strength porous carbon framework can provide stable support for silicon materials, reducing the stress caused by volume expansion of silicon materials during charging and discharging, thereby reducing the breakage of the silicon-carbon material. Additionally, the cross-linked structure of the porous carbon can form a conductive network, enhancing the conductivity of the porous carbon, enabling the secondary battery to have high energy density while improving the expansion suppression performance, cycling performance, and rate performance of the secondary battery.

### BRIEF DESCRIPTION OF DRAWINGS

FIG. 1 is a pore distribution diagram of a porous carbon material of Example 1-4;

FIG. 2 is an adsorption-desorption isotherm diagram of a porous carbon material of Example 1-4;

FIG. 3 is an XRD diagram of a porous carbon material of Example 1-4;

FIG. 4 is an SEM image of a surface morphology of a porous carbon material of Example 1-4; and

FIG. 5 is an SEM image of a cross-sectional morphology of a porous carbon material of Example 1-4.

### DETAILED DESCRIPTION

To make the objectives, technical solutions, and advantages of this application clearer, this application is further described in detail below with reference to embodiments. It should be understood that the specific embodiments described herein are merely illustrative of this application and are not intended to limit this application.

Silicon-carbon materials, due to their high lithium storage capacity, are commonly used as negative electrode materials for lithium-ion batteries to enhance the overall energy density of secondary batteries. Silicon-carbon materials are typically prepared from porous carbon through silane vapor deposition. During the study of silicon-carbon materials, the inventors have found that silicon-carbon materials often break due to insufficient strength when subjected to rolling in electrode plate manufacturing, exposing silicon and causing interfacial side reactions with the electrolyte, thereby affecting the long-term cycling performance of secondary batteries.

In view of this, according to a first aspect, this application provides a porous carbon material, where based on a pore volume of the porous carbon material, a volume proportion of ultramicropores with a pore diameter less than or equal to 0.7 nm is denoted as P₀%, and a volume proportion of micropores with a pore diameter less than or equal to 2 nm is denoted as P₁%, where 2≤P₀≤28 and 92≤P₁≤100. In some embodiments, P₀ is 2, 3, 5, 6, 7, 8, 9, 11, 12, 13, 15, 16, 18, 19, 21, 22, 23, 24, 26, 27, 28, or a value within a range defined by any two of these values. In some embodiments, P₁ is 92, 93, 94, 95, 96, 97, 98, 99, 100, or a value within a range defined by any two of these values. This application controls the volume proportions of ultramicropores and micropores in the porous carbon material to meet the above ranges. Micropores provide conditions for diffusion of silane gas, facilitating uniform deposition of nanosilicon and reducing volume expansion of large silicon particles. The combination of ultramicropores and micropores facilitates formation of a highly compact cross-linked network structure within the porous carbon. This not only creates a conductive network within the silicon-carbon material to enhance the conductivity of the silicon-carbon material, but also increases the structural stability and compressive strength of the porous carbon material, reduces volume changes and stresses of silicon during charging and discharging, and mitigates structural damage caused by volume expansion or contraction of the silicon material during charging and discharging, thereby improving the rate performance, expansion suppression performance, and cycling performance of the secondary battery. Preferably, 6.5≤P₀≤19.5 and 95≤P₁≤100. The porous carbon material meeting these conditions can further improve the rate performance, expansion suppression performance, and cycling performance of the secondary battery.

In some embodiments, a specific surface area of the porous carbon material is denoted as SA m²/g, where 1059≤SA≤2486. For example, SA is 1059, 1065, 1170, 1223, 1321, 1412, 1484, 1577, 1630, 1667, 1738, 1851, 1914, 1985, 2041, 2115, 2207, 2280, 2358, 2416, 2486, or a value within a range defined by any two of these values. This application controls the specific surface area of the porous carbon material to meet the above range. A relatively high specific surface area helps increase adsorption of silane gas during the preparation of the silicon-carbon material, and in combination with the above micropore structure, promotes uniform deposition of nanosilicon, and enabling the porous carbon material to have an appropriate pore volume, enhancing the compressive strength of the porous carbon material, and improving the expansion suppression performance and cycling performance of the secondary battery. On the other hand, a high specific surface area also promotes the intercalation and deintercalation of active materials such as lithium ions in the silicon-carbon material, and in combination with the conductive structure of the cross-linked network, further improves the rate performance of the secondary battery.

In some embodiments, a pore volume of the porous carbon material is denoted as Pv cm³/g, where 0.52≤Pv≤1.6. For example, Pv is 0.52, 0.55, 0.60, 0.69, 0.75, 0.79, 0.81, 0.90, 0.94, 1.00, 1.09, 1.11, 1.16, 1.22, 1.31, 1.32, 1.38, 1.45, 1.53, 1.56, 1.6, or a value within a range defined by any two of these values. The pore volume of the porous carbon material is controlled within the above range, allowing the porous carbon material to have both high silicon load and compressive strength, and resulting in a silicon-carbon material with high energy density and structural stability, enabling the secondary battery to have high energy density while maintaining excellent expansion suppression performance and cycling performance.

In some embodiments, a compressive strength of the porous carbon material is denoted as CS MPa, where 161≤CS≤1968; preferably, 1096≤CS≤1878. For example, CS is 161, 219, 280, 366, 456, 549, 705, 774, 861, 955, 1096, 1120, 1268, 1381, 1458, 1558, 1604, 1752, 1878, 1940, 1968, or a value within a range defined by any two of these values. This application controls the compressive strength of the porous carbon material to meet the above range, and in combination with the above pore structure characteristics, can resist volume expansion during subsequent lithium-ion intercalation in the silicon-carbon material, reducing the breakage of the silicon-carbon material caused by expansion and the material breakage caused by rolling in manufacturing of battery materials such as electrode plates. This reduces or avoids exposure of active silicon caused by breakage of the silicon-carbon material, as well as side reactions with the electrolyte, thereby improving the cycling performance and expansion suppression performance of the secondary battery.

In some embodiments, an average ellipticity of the porous carbon material is denoted as ERm, where 0.91≤ERm≤1. For example, ERm is 0.91, 0.92, 0.93, 0.94, 0.95, 0.96, 0.97, 0.98, 0.99, 1, or a value within a range defined by any two of these values. With the average ellipticity of the porous carbon material controlled to meet the above range, together with the pore structure characteristics of the porous carbon material, the stress received by the silicon-carbon material during the rolling process can be further reduced, and breakage of the silicon-carbon material and subsequent side reactions with the electrolyte can be reduced, thereby improving the cycling performance of the secondary battery.

In some embodiments, a particle size Dᵥ50 of the porous carbon material is denoted as D μm, where 5.2≤D≤9.8. For example, D is 5.2, 5.3, 5.5, 5.7, 6.0, 6.2, 6.6, 6.9, 7.0, 7.3, 7.4, 7.7, 8.1, 8.3, 8.5, 8.8, 9.0, 9.1, 9.5, 9.7, 9.8, or a value within a range defined by any two of these values. This application controls the particle size Dᵥ50 of the porous carbon material to meet the above range, allowing the porous carbon material to have both high compressive strength and appropriate specific surface area, reducing the side reactions between the silicon-carbon material and the electrolyte, and improving the expansion suppression performance and cycling performance of the secondary battery.

In some embodiments, particle size distribution of the porous carbon material further includes: Dᵥ10≥2 μm, and Dᵥ99≤30 μm.

In some embodiments, a compacted density of the porous carbon material under a force of 5000 kgf is denoted as ρ g/cm³, where 0.45≤ρ≤0.7. For example, ρ is 0.45, 0.46, 0.47, 0.48, 0.49, 0.51, 0.52, 0.54, 0.55, 0.56, 0.58, 0.59, 0.60, 0.61, 0.62, 0.64, 0.65, 0.67, 0.68, 0.69, 0.7, or a value within a range defined by any two of these values. With the compacted density of the porous carbon material controlled within the above range, together with its micropore structure, the energy density of the silicon-carbon material can be enhanced, and a relatively high compressive strength can be achieved, improving the expansion suppression performance and cycling performance of the secondary battery.

In some embodiments, in a Raman spectrum of the porous carbon material, 0.8≤ID/IG≤1.5. For example, a value of ID/IG is 0.8, 0.9, 1.0, 1.1, 1.2, 1.3, 1.4, 1.5, or a value within a range defined by any two of these values. This application controls the value of ID/IG to meet the above range, which can increase the active sites for silicon deposition in the porous carbon material, and reduce the proportion of defect sites. This helps increase silicon load and deposition uniformity, enhances the structural stability of the silicon-carbon material, and achieves high conductivity, thereby improving the expansion suppression performance, rate performance, and cycling performance of the secondary battery.

According to a second aspect, this application provides a preparation method of the porous carbon material according to any one of the above embodiments, including the following steps: step 1. subjecting a phenolic compound, an acidic catalyst, a stabilizer, and an aldehyde compound to gradient heat preservation treatment under an inert atmosphere to obtain an organic precursor, where the gradient heat preservation treatment includes: performing a first heat preservation treatment at a first temperature T₁° C. for a heat preservation duration of t₁ h, and then performing a second heat preservation treatment at a second temperature T₂° C. for a heat preservation duration of t₂ h; where 20≤T₁≤100; 0.5≤t₁≤6; 60≤T₂≤150; and 0.5≤t₂≤16; and a mass ratio of the phenolic compound, the acidic catalyst, and the aldehyde compound is 1:(1-5):(2-5); step 2. sequentially subjecting the organic precursor to curing treatment and carbonization treatment to obtain a carbide; and step 3. mixing the carbide with an activator, followed by activation treatment to obtain the porous carbon material, where the activator includes potassium hydroxide and sodium carbonate, a mass ratio of the potassium hydroxide to the sodium carbonate being 1:(0.1-0.3); and the activation treatment is performed at a temperature T₅° C. for a duration of t₅ h, where 621≤T₅≤854; and 0.5≤t₅≤6. In this application, the phenolic compound, aldehyde compound, acidic catalyst, and stabilizer are subjected to gradient heat preservation treatment, enhancing the cross-linking degree and mechanical strength of the organic precursor. In conjunction with the conditions of the subsequent activation treatment, the different activities of potassium hydroxide and sodium carbonate are utilized to intercalate them into the carbide framework, forming micropore and ultramicropore structures. This creates a highly compact cross-linked structure within the porous carbon, and helps control the pore volume and specific surface area of the porous carbon, resulting in a porous carbon material with high compressive strength.

The inventors have found that porous carbon materials typically use biomass, petroleum coke, resin, or the like as the precursor. Biomass inherently contains many macropores, so the matrix strength is low, making it difficult to enhance its strength through modification. Petroleum coke itself belongs to soft carbon, and particles of the porous carbon material prepared therefrom also exhibit low compressive strength. Due to differences in preparation processes, resin materials with different matrices also exhibit significant differences in the strength of the derived carbon skeleton. Due to the low strength of the carbon matrix skeleton, which hardly provides sufficient strength support for silicon-carbon material particles, during preparation of negative electrode plates, to enhance volumetric energy density, electrode plates are rolled. As a result, silicon-carbon particles are broken due to rolling, and silicon material is exposed and reacts with the electrolyte, continuously forming SEI. As the cycling progresses, the SEI thicken and consume the silicon material and electrolyte, leading to overall cycle life degradation. This application enhances the cross-linking degree of the organic precursor, and in combination with the activation treatment step, forms ultramicropore and micropore distribution structures in the porous carbon material, to increase the compressive strength of the porous carbon material, thereby enhancing the compressive resistance of the silicon-carbon material itself. Additionally, in combination of conditions such as carbonization treatment and activation treatment, a porous carbon material with a certain specific surface area and pore volume is prepared. The pore volume and pore size distributions are regulated, allowing for appropriate silicon deposition. The reserved pore volume provides space for lithium intercalation expansion of silicon to buffer silicon volume expansion, thereby leveraging the high energy density characteristics of the silicon material while improving the expansion suppression performance, cycling performance, and rate performance of the secondary battery.

In some embodiments, in the gradient heat preservation treatment, 20≤T₁≤100; and 0.5≤t₁≤6. For example, T₁ is 20, 21, 26, 32, 33, 39, 42, 46, 52, 58, 59, 66, 69, 73, 75, 81, 86, 91, 94, 96, 100, or a value within a range defined by any two of these values, and t₁ is 0.5, 0.9, 1.1, 1.6, 2.1, 2.4, 2.9, 3.4, 3.5, 4.1, 4.6, 5.0, 5.3, 5.7, 6, or a value within a range defined by any two of these values.

In some embodiments, 60≤T₂≤150; and 0.5≤t₂≤16. For example, T₂ is 60, 62, 68, 72, 75, 82, 87, 92, 98, 102, 105, 111, 115, 117, 122, 129, 134, 139, 145, 148, 150, or a value within a range defined by any two of these values, and t₂ is 0.5, 0.8, 1.3, 2.2, 3.0, 4.4, 5.3, 5.6, 6.3, 7.5, 8.7, 9.3, 10.1, 10.8, 11.5, 12.7, 13.1, 13.7, 14.6, 15.6, 16, or a value within a range defined by any two of these values.

In some embodiments, T₁<T₂. Controlling the above gradient heat preservation treatment conditions can enhance the cross-linking degree of the organic precursor, facilitating subsequent formation of an appropriate micropore structure.

In some embodiments, a mass ratio of the phenolic compound, the acidic catalyst, and the aldehyde compound is 1:(1-5):(2-5). For example, when a mass proportion of the phenolic compound is 1 part, a mass proportion of the acidic catalyst is 1 part, 2 parts, 3 parts, 4 parts, 5 parts, or a value within a range defined by any two of these values, and a mass proportion of the aldehyde compound is 2 parts, 3 parts, 4 parts, 5 parts, or a value within a range defined by any two of these values.

In some embodiments, 621≤T₅≤854; and 0.5≤t₅≤6. For example, T₅ is 621, 625, 642, 650, 658, 678, 688, 705, 716, 723, 738, 754, 763, 778, 784, 798, 817, 818, 839, 853, 854, or a value within a range defined by any two of these values, and t₅ is 0.5, 0.9, 1.1, 1.6, 2.1, 2.4, 2.9, 3.4, 3.5, 4.1, 4.6, 5.0, 5.3, 5.7, 6, or a value within a range defined by any two of these values. This application promotes the formation of sufficient pore structures in the carbide and enhances the structural strength of the porous carbon precursor by controlling the temperature and duration of the activation treatment.

In some embodiments, the phenolic compound includes at least one of phenol, resorcinol, phloroglucinol, or bisphenol A.

In some embodiments, the acidic catalyst includes at least one of hydrochloric acid, sulfuric acid, nitric acid, or oxalic acid.

In some embodiments, the aldehyde compound includes at least one of formaldehyde, paraformaldehyde, furfural, or acetaldehyde.

In some embodiments, the stabilizer includes at least one of polyvinyl alcohol (PVA), polyethylene glycol (PEG), hydroxymethyl cellulose (HEC), carboxymethyl cellulose (CMC), or polyvinylpyrrolidone (PVP).

In some embodiments, a mass ratio of the phenolic compound to the stabilizer is 1:(0.01-2.8). For example, when a mass proportion of the phenolic compound is 1 part, a mass proportion of the stabilizer is 0.01 part, 0.13 part, 0.17 part, 0.36 part, 0.50 part, 0.73 part, 0.79 part, 1.00 part, 1.07 parts, 1.24 parts, 1.47 parts, 1.50 parts, 1.63 parts, 1.90 parts, 2.05 parts, 2.11 parts, 2.36 parts, 2.45 parts, 2.53 parts, 2.65 parts, 2.8 parts, or a value within a range defined by any two of these values.

In some embodiments, the curing treatment is performed at a temperature T₃° C. for a duration of t₃ h; where 40≤T₃≤120; and 0.5≤t₃≤6. For example, T₃ is 40, 42, 46, 49, 54, 59, 62, 65, 70, 75, 78, 86, 88, 93, 98, 102, 105, 111, 113, 119, 120, or a value within a range defined by any two of these values, and t₃ is 0.5, 0.9, 1.1, 1.6, 2.1, 2.4, 2.9, 3.4, 3.5, 4.1, 4.6, 5.0, 5.3, 5.7, 6, or a value within a range defined by any two of these values.

In some embodiments, the curing treatment includes: mixing the organic precursor with a curing agent and performing the curing treatment at a temperature T₃° C. for a duration of t₃ h. Optionally, the curing agent includes at least one of ammonia, hexamethylenetetramine, melamine, or triethylamine. Optionally, a mass concentration of the curing agent is 0.05% to 20%. These curing agents can participate in altering the molecular structure and properties of the organic precursor, enhancing the polymerization and curing degree of the organic precursor, facilitating improved effects in subsequent carbonization treatment and activation treatment.

In some embodiments, the carbonization treatment is performed under an inert atmosphere, where the inert atmosphere is selected from at least one of nitrogen or argon.

In some embodiments, the carbonization treatment is performed at a temperature T₄° C. for a duration of t₄ h; where 500≤T₄≤1000; and 0.5≤t₄≤6. For example, T₄ is 500, 540, 570, 600, 630, 660, 680, 700, 710, 740, 760, 790, 820, 850, 870, 900, 940, 950, 990, 1000, or a value within a range defined by any two of these values, and t₄ is 0.5, 0.9, 1.1, 1.6, 2.1, 2.4, 2.9, 3.4, 3.5, 4.1, 4.6, 5.0, 5.3, 5.7, 6, or a value within a range defined by any two of these values. The temperature and duration of the carbonization treatment are regulated so that the residual organic content can be reduced and a relatively compact pore structure is formed, facilitating subsequent activation, and promoting the formation of a spherical morphology in the carbon precursor.

In some embodiments, a mass ratio of the carbide to the activator is denoted as w, where 0.1≤w≤1. For example, w is 0.1, 0.2, 0.3, 0.4, 0.5, 0.6, 0.7, 0.8, 0.9, 1, or a value within a range defined by any two of these values. This application controls the mass ratio of the carbide to the activator within the above range, which can enhance the activation effect of the carbide, form an appropriate micropore structure, and improve the compressive strength of the porous carbon material.

In some embodiments, after the activation treatment and cooling to room temperature, the material is removed, washed multiple times with deionized water, neutralized with a small amount of hydrochloric acid to remove impurities, and then the material is dried at 120° C. for 12 h to obtain the porous carbon material.

According to a third aspect, this application provides a silicon-carbon material including the porous carbon material provided in the first aspect or the porous carbon material obtained using the preparation method provided in the second aspect. The silicon-carbon material of this application utilizes the micropore structure of the porous carbon material to enhance compressive strength. This, on one hand, can resist breakage under pressure during the rolling process to maintain the structural integrity of the silicon-carbon material, and on the other hand, constrain volume expansion caused by lithium-ion intercalation, thereby enabling the secondary battery to have excellent cycling and expansion performance when applied in the secondary battery. Additionally, the conductive network and high specific surface area of the porous carbon help improve the rate performance of the secondary battery.

This application imposes no special restrictions on the preparation method of the silicon-carbon material, as long as the objectives of this application can be achieved. For example, with the porous carbon material provided in the first aspect as a skeleton, nanosized silicon particles are deposited on the surface and/or within the pores of the porous carbon skeleton through silane vapor deposition, so as to prepare the silicon-carbon material.

In some embodiments, the silicon-carbon material includes the porous carbon material and a silicon material located on a surface and/or within the pores of the porous carbon material. When the porous carbon material provided in this application is used as a framework for silane vapor deposition, the nanoscale pore channels can restrict the growth of silicon grains, limiting silicon grains to the nanoscale scale. This prevents the pulverization issue caused by lithium intercalation induced-expansion of large silicon particles. Therefore, the material, when applied to the secondary battery, enables the secondary battery to have high energy density, expansion suppression performance, and cycling performance.

According to a fourth aspect, this application provides a secondary battery including a positive electrode, a negative electrode, and an electrolyte, where the negative electrode includes a negative electrode current collector and a negative electrode active material layer disposed on at least one surface of the negative electrode current collector; and the negative electrode active material layer includes the silicon-carbon material provided in the third aspect.

The secondary battery of this application is not particularly limited and may include, but is not limited to, a lithium-ion secondary battery (also referred to as a lithium-ion battery) or a sodium-ion secondary battery.

In this application, the “negative electrode active material layer disposed on at least one surface of the negative electrode current collector” means that the negative electrode active material layer may be disposed on one surface of the negative electrode current collector in a thickness direction or on both surfaces of the negative electrode current collector in the thickness direction. It should be noted that the “surface” herein may refer to the entire area of the negative electrode current collector or a partial area of the negative electrode current collector. This application imposes no particular restrictions on this, as long as the objectives of this application can be achieved. This application imposes no particular restrictions on the thickness of the negative electrode active material layer, as long as the objectives of this application can be achieved. For example, a thickness of the negative electrode active material layer on a single side may be 30 μm to 160 μm.

In some embodiments, the negative electrode active material layer further includes natural graphite and/or artificial graphite.

This application imposes no particular restrictions on the negative electrode current collector, as long as the objectives of this application can be achieved. For example, the negative electrode current collector may include copper foil, aluminum foil, copper alloy foil, nickel foil, stainless steel foil, titanium foil, nickel foam, copper foam, a composite current collector (for example, a carbon-copper composite current collector, a nickel-copper composite current collector, or a titanium-copper composite current collector), a polymer substrate coated with conductive metal, or any combination thereof. This application imposes no particular restrictions on the thickness of the negative electrode current collector, as long as the objectives of this application can be achieved. For example, the thickness of the negative electrode current collector is 4 μm to 10 μm.

In this application, the negative electrode active material layer may further include a negative electrode binder, where the negative electrode binder may include, but is not limited to, at least one of polyvinyl alcohol, carboxymethyl cellulose, hydroxypropyl cellulose, diacetyl cellulose, polyvinyl chloride, carboxylated polyvinyl chloride, polyvinyl fluoride, polymers containing ethylene oxide, polyvinylpyrrolidone, polyurethane, polytetrafluoroethylene, polyvinylidene fluoride, polyethylene, polypropylene, polyacrylic acid (PAA), styrene-butadiene rubber, acrylated styrene-butadiene rubber, epoxy resin, or nylon.

In this application, the negative electrode active material layer may further include a conductive agent. This application imposes no particular restrictions on a type of the conductive agent in the negative electrode active material layer, as long as the objectives of this application can be achieved. For example, the conductive agent may include, but is not limited to, a carbon-based material, a metal-based material, a conductive polymer, and a mixture thereof. In some embodiments, the carbon-based material is selected from carbon black, acetylene black, Ketjen black, carbon fiber, or any combination thereof. In some embodiments, the metal-based material is selected from metal powder, metal fiber, copper, nickel, aluminum, or silver. In some embodiments, the conductive polymer is a polyphenylene derivative. This application imposes no particular restrictions on the mass ratio of the negative electrode material, conductive agent, and negative electrode binder in the negative electrode active material layer, as long as the objectives of this application can be achieved. For example, a loading amount of the negative electrode active material in the negative electrode plate is 1.0 mg/cm² to 1.5 mg/cm².

In this application, the positive electrode is not particularly limited, as long as the objectives of this application can be achieved. For example, the positive electrode includes a positive electrode current collector and a positive electrode active material layer located on at least one surface of the positive electrode current collector. The “positive electrode active material layer located on at least one surface of the positive electrode current collector” means that the positive electrode active material layer may be located on one surface of the positive electrode current collector in a thickness direction or on both surfaces of the positive electrode current collector in the thickness direction. It should be noted that the “surface” herein may refer to the entire area of the positive electrode current collector surface or a partial area of the positive electrode current collector surface. This application imposes no particular restrictions on this, as long as the objectives of this application can be achieved.

This application imposes no particular restrictions on the positive electrode current collector, as long as the objectives of this application can be achieved. For example, the positive electrode current collector may include aluminum foil, aluminum alloy foil, or a composite current collector (for example, an aluminum-carbon composite current collector). The composite current collector may be formed by forming a metal material (copper, copper alloy, nickel, nickel alloy, titanium, titanium alloy, silver, silver alloy, or the like) on a polymer substrate.

The positive electrode active material layer of this application includes a positive electrode active material. This application imposes no particular restrictions on a type of the positive electrode active material, as long as the objectives of this application can be achieved. For example, the positive electrode active material may include at least one of lithium nickel cobalt manganese oxide (LiNi_{0.90}Co_{0.05}Mn_{0.05}O₂ (NCM955), NCM811, NCM622, NCM523, NCM111), lithium nickel cobalt aluminum oxide, lithium iron phosphate, lithium vanadium phosphate, lithium cobalt phosphate, lithium manganese phosphate, lithium manganese iron phosphate, lithium-rich manganese-based materials, lithium cobalt oxide (LiCoO₂), lithium iron silicate, lithium vanadium silicate, lithium cobalt silicate, lithium manganese silicate, spinel-type lithium manganese oxide, spinel-type nickel manganese oxide, or lithium titanate. In this application, the positive electrode active material may further include a non-metal element. For example, the non-metal element includes at least one of fluorine, phosphorus, boron, chlorine, silicon, or sulfur. In this application, the thicknesses of the positive electrode current collector and the positive electrode active material layer are not particularly limited, as long as the objectives of this application can be achieved. For example, the thickness of the positive electrode current collector is 5 μm to 20 μm, and the thickness of the positive electrode active material layer on a single side is 30 μm to 120 μm.

In this application, the positive electrode active material layer may further include a positive electrode binder and a conductive agent. This application imposes no particular restrictions on a type of the positive electrode binder in the positive electrode active material layer, as long as the objectives of this application can be achieved. For example, the positive electrode binder may include, but is not limited to, at least one of polyvinylidene fluoride, polytetrafluoroethylene, polyolefins, sodium carboxymethyl cellulose, lithium carboxymethyl cellulose, modified polyvinylidene fluoride, modified styrene-butadiene rubber (SBR), or polyurethane. In some embodiments, the polyolefin binder includes at least one of polyethylene, polypropylene, polyolefin ester, polyolefin alcohol, or polyacrylic acid.

This application imposes no particular restrictions on a type of the conductive agent in the positive electrode active material layer, as long as the objectives of this application can be achieved. For example, the type of the conductive agent may be the same as that of the conductive agent in the negative electrode active material layer. In some embodiments, the conductive agent includes a carbon-based material, such as natural graphite, artificial graphite, carbon black, acetylene black, Ketjen black, or carbon fiber; a metal-based material, such as metal powder or metal fiber of copper, nickel, aluminum, silver, or the like; a conductive polymer, such as a polyphenylene derivative; or a mixture thereof. This application imposes no particular restrictions on a mass ratio of the positive electrode active material, conductive agent, and positive electrode binder in the positive electrode active material layer, which can be selected by those skilled in the art according to actual needs, as long as the objectives of this application can be achieved. For example, a loading amount of the positive electrode active material in the positive electrode plate is 4.0 mg/cm² to 10.0 mg/cm².

In this application, the secondary battery further includes an electrolyte. According to some embodiments of this application, the electrolyte includes a lithium salt and a non-aqueous solvent. The lithium salt may include, but is not limited to, at least one of lithium hexafluorophosphate (LiPF₆), lithium tetrafluoroborate (LiBF₄), lithium difluorophosphate (LiPO₂F₂), lithium bis(trifluoromethanesulfonyl)imide {LiN(CF₃SO₂)₂, LiTFSI}, lithium bis(fluorosulfonyl)imide {Li(N(SO₂F)₂), LiFSI}, lithium bis(oxalato)borate {LiB(C₂O₄)₂, LiBOB}, lithium difluoro(oxalato)borate {LiBF₂(C₂O₄), LiDFOB}, LiNO₃, LiClO₄, LiB(C₆H₅)₄, LiCH₃SO₃, LiCF₃SO₃, LiC(SO₂CF₃)₃, Li₂SiF₆, lithium bis(trifluoromethanesulfonyl)imide (LiTFSI), or lithium difluoroborate. This application imposes no restrictions on the content of the lithium salt in the electrolyte, as long as the objectives of this application can be achieved. This application imposes no particular restrictions on the non-aqueous solvent, as long as the objectives of this application can be achieved. For example, the non-aqueous solvent may include, but is not limited to, at least one of a carbonate compound, a carboxylate compound, an ether compound, or other organic solvents. The carbonate compound may include, but is not limited to, at least one of a linear carbonate compound, a cyclic carbonate compound, or a fluorinated carbonate compound. The linear carbonate compound may include, but is not limited to, at least one of dimethyl carbonate (DMC), diethyl carbonate (DEC), dipropyl carbonate, methyl propyl carbonate, ethyl propyl carbonate, or ethyl methyl carbonate (EMC). The cyclic carbonate may include, but is not limited to, at least one of ethylene carbonate (EC), propylene carbonate (PC), butylene carbonate, or vinyl ethylene carbonate. The fluorinated carbonate compound may include, but is not limited to, at least one of fluoroethylene carbonate, 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolide, valerolactone, or caprolactone. The ether compound may include, but is not limited to, at least one of 1,3-dioxolane (DOL), ethylene glycol dimethyl ether (1,2-dimethoxyethane, DME), dibutyl ether, tetraethylene glycol dimethyl ether, diethylene glycol dimethyl ether, 1,2-diethoxyethane, 1-ethoxy-1-methoxyethane, 2-methyltetrahydrofuran, or tetrahydrofuran. The other organic solvents may include, but are not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

The secondary battery of this application further includes a separator. The material and shape of the separator used in the secondary battery of this application are not particularly limited and may be any technology disclosed in the prior art. In some embodiments, the separator includes a polymer formed from a material stable to the electrolyte of this application, an inorganic material, or the like.

For example, the separator may include a substrate layer and a surface treatment layer. The substrate layer is a non-woven fabric, membrane, or composite membrane with a porous structure, and a material of the substrate layer is selected from at least one of polyethylene, polypropylene, polyethylene terephthalate, or polyimide. Specifically, a polypropylene porous membrane, a polyethylene porous membrane, a polypropylene non-woven fabric, a polyethylene non-woven fabric, or a polypropylene-polyethylene-polypropylene porous composite membrane may be selected.

At least one surface of the substrate layer is provided with the surface treatment layer. The surface treatment layer may be a polymer layer or an inorganic layer, or a layer formed by mixing a polymer and an inorganic material. The inorganic layer includes inorganic particles and a binder. The inorganic particles are selected from at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is selected from at least one of polyvinylidene fluoride, a copolymer of vinylidene fluoride-hexafluoropropylene, polyamide, polyacrylonitrile, polyacrylate, polyacrylic acid, polyacrylate salt, polyvinylpyrrolidone, polyvinylether, polymethyl methacrylate, polytetrafluoroethylene, or polyhexafluoropropylene. The polymer layer includes a polymer, and a material of the polymer is selected from at least one of polyamide, polyacrylonitrile, acrylate polymer, polyacrylic acid, polyacrylate salt, polyvinylpyrrolidone, polyvinylether, polyvinylidene fluoride, or poly(vinylidene fluoride-hexafluoropropylene).

The secondary battery of this application further includes a packaging bag for accommodating the positive electrode plate, negative electrode plate, separator, electrolyte, and other components known in the art in secondary batteries, where the other components are not limited in this application. This application imposes no particular restrictions on the packaging bag, which may be a packaging bag known in the art, as long as the objectives of this application can be achieved.

The preparation process of the secondary battery of this application is well known to those skilled in the art, and this application imposes no particular restrictions. For example, the process may include, but is not limited to, the following steps: stacking the positive electrode plate, separator, and negative electrode plate in order, and winding or folding as needed to obtain an electrode assembly with a wound structure, placing the electrode assembly in a packaging bag, injecting the electrolyte into the packaging bag, and performing sealing to obtain the secondary battery; or stacking the positive electrode plate, separator, and negative electrode plate in order, fixing the four corners of the entire stacked structure with tapes to obtain an electrode assembly with a stacked structure, placing the electrode assembly in a packaging bag, injecting the electrolyte into the packaging bag, and performing sealing to obtain the secondary battery. Additionally, overcurrent protection elements, guide plates, and the like may be placed in the packaging bag as needed to prevent pressure buildup, overcharging, and overdischarging inside the secondary battery.

According to a fifth aspect, this application provides an electronic device including the secondary battery provided in the fourth aspect.

The electronic device of this application is not particularly limited and may be any electronic device known in the prior art. For example, the electronic device may include, but is not limited to, a notebook computer, a pen-input computer, a mobile computer, an e-book reader, a portable phone, a portable fax machine, a portable copier, a portable printer, a head-mounted stereo headset, a video recorder, an LCD TV, a portable cleaner, a portable CD player, a mini-disc player, a transceiver, an electronic organizer, a calculator, a memory card, a portable recorder, a radio, a backup power supply, a motor, an automobile, a motorcycle, an assisted bicycle, a bicycle, a lighting fixture, a toy, a gaming console, a clock, an electric tool, a flashlight, a camera, a large household battery, and a lithium-ion capacitor.

The following takes lithium-ion batteries as an example to illustrate the solutions of this application in conjunction with specific embodiments. Unless otherwise specified, the raw materials used in the following examples are all commercially available conventional products, and the apparatuses or devices used are all purchased from conventional market channels.

### Test Methods

SPECIFIC surface area, pore volume, and pore size testing:

The porous carbon material was tested using a physical adsorption instrument (model: ipore 620). The process are as follows: 0.15 g of the porous carbon material was taken as a sample and placed in a sample tube. The sample was degassed at 200° C. for 6 h, and then the argon adsorption amount of the sample was measured at different relative pressures to plot the isothermal adsorption curve of sample. The specific surface area of the sample was calculated using BET fitting, the single-point adsorption pore volume of the sample was calculated, and the pore size distribution was determined using NLDFT, thereby calculating the volume proportions of ultramicropores and micropores based on the pore volume.

### Compressive Strength Testing:

A micro-particle compression tester (model: MCT-210) was used for testing. 0.05 g of the porous carbon material to be tested was ultrasonically dispersed in 10 ml of ethanol, and the dispersion was taken to the test platform. After the dispersion was dried, a single particle of the porous carbon material was randomly selected as the test particle sample, and the compressive strength of the test particle sample was measured. The compressive strength=2.48×P/(3.14×d×d), where d is the diameter of the test particle sample and P is the pressure at which the test particle sample breaks. A total of 10 test particle samples were selected, and the arithmetic average of the compressive strengths of the 10 test particle samples was calculated to obtain the compressive strength of the porous carbon material to be tested.

### Average Ellipticity Testing:

A particle sphericity analyzer (model: Occhio 500 nanoXY) was used for testing. 0.5 g of the porous carbon material sample was ultrasonically dispersed in 10 ml of ethanol, and the dispersion was added to the instrument for sphericity analysis of the sample to obtain the average ellipticity of the porous carbon material sample.

### Particle Size Testing:

A Malvern particle size analyzer (model: Mastersizer 3000) was used to measure the particle size of the porous carbon material. The porous carbon material sample was dispersed in water and ultrasonicated for 30 minutes. The dispersion sample was added to the Malvern particle size analyzer to test the particle size distribution of the porous carbon material, thereby obtaining the Dᵥ10, Dᵥ50, and Dᵥ99 of the porous carbon material sample to be tested.

### Compacted Density Testing:

A powder compacted density tester (model: UTM 7305) was used to test the compacted density of the porous carbon material. The porous carbon material sample was added to a compaction mold, and the compaction mold was placed on the powder compacted density tester to test the compacted density of the porous carbon material sample under a force of 5000 kgf.

### ID/IG Testing:

A Raman spectrometer (model: HR Evolution) was used to analyze the graphitization degree (ID/IG) of the porous carbon material. The porous carbon material sample was placed in a sample slot, and the surface was flattened using a glass slide. The Raman spectrometer was used to collect the spectrum of the porous carbon material sample in the range of 150 cm⁻¹ to 3500 cm⁻¹, and then the ID/IG value of the porous carbon material sample was analyzed.

### Surface Morphology Testing of Porous Carbon Material:

A scanning electron microscope (model: sigma-02-33) was used to analyze the surface morphology characteristics of the porous carbon material sample. The porous carbon material sample to be tested was dispersed on conductive adhesive, and the surface morphology characteristics were observed under different magnifications (500-30000×) using the scanning electron microscope.

### Cross-Sectional Morphology Testing of Porous Carbon Material:

A scanning electron microscope (model: sigma-02-33) was used to analyze the cross-sectional morphology characteristics of the porous carbon material sample. The porous carbon material was evenly mixed with the binder and applied to the copper foil to obtain the sample to be tested. The sample to be tested was subjected to argon ion cross-sectional polishing to obtain the CP sample, and the cross-sectional morphology characteristics of the CP sample were observed using the scanning electron microscope.

### XRD Testing:

An XRD powder diffractometer (model: BRUKER D8 Advance) was used for testing. The porous carbon material was taken as the sample to be tested. The sample to be tested was sieved through a 200-mesh sieve, and the undersize powder was loaded into a sample holder. The surface was flattened, and excess powder around the edges was removed. The prepared sample to be tested was placed in the XRD powder diffractometer for testing, and the XRD pattern was collected.

### Rate Performance Testing:

The lithium-ion battery of the example/comparative example to be tested was taken and left standing for 5 min at a test temperature of 25° C. Then the lithium-ion battery was charged at a constant current of 0.7C to 4.45 V, charged at a constant voltage of 4.45 V to 0.05C, left standing for 5 min, and then discharged at a constant current of 0.2C to 3.0 V, and the 0.2C discharge capacity was record. The lithium-ion battery was left standing for 5 min, and the above charging process was repeated. Then the lithium-ion battery was discharged at a constant current of 2C, and the 2C discharge capacity was recorded. Rate capacity retention rate=2C discharge capacity/0.2C discharge capacity×100%.

### Cycling Performance Testing:

At a test temperature of 25° C., the lithium-ion battery to be tested was left standing for 5 min, and the initial thickness MMC0 of the lithium-ion battery was recorded. The lithium-ion battery was subjected to 3.4C staged charging, where 3.4C staged charging included: charging the lithium-ion battery at a constant current of 3.4C to 4.25 V, then charging at a constant current of 2C to 4.4 V, then charging at a constant current of 1C to 4.50 V, and then charging at constant voltage of 4.50 V to 0.05C. Then the lithium-ion battery is left standing for 5 min, discharged at a constant current of 0.5C to 3.0 V, and then left standing for 5 min, and the discharge capacity C1 of the lithium-ion battery was recorded. After the above 3.4C staged charging/0.5C discharging cycle process was repeated 400 times, the thickness MMC1 and the discharge capacity C2 of the lithium-ion battery were recorded.

$$Cycling capacity retention rate ( \% ) = C 2 / C 1 \times 100 \% .$$

$$Cycling thickness swelling rate ( \% ) = ( MMC 1 - MMC 0 ) / MMC 0 \times 100 \% .$$

### Example 1-1

### Preparation of Porous Carbon Material

The preparation method of the porous carbon material in this example includes the following steps.

Step 1: The phenol (phenolic compound), hydrochloric acid (acidic catalyst), and polyvinyl alcohol (stabilizer) were added to a three-neck flask at a mass ratio of 1:2:1.7, and mixed to uniformity; an aqueous solution of formaldehyde (aldehyde compound) is added, controlling the mass ratio of phenol to formaldehyde to 1:2; and a resulting mixture was subjected to gradient heat preservation treatment under an inert atmosphere. The gradient heat preservation treatment included: subjecting to reaction at 100° C. (first temperature T₁° C.) for 2 h (t₁ h), and then performing second heat preservation treatment at 150° C. (second temperature T₂° C.) for 2 h (t₂ h). After filtration, the mixture was washed with clean water to obtain an organic precursor.

Step 2: The organic precursor was mixed with ammonia water (curing agent) at a mass concentration of 2%, and then subjected to curing treatment at 60° C. (T₃° C.) for 2 h (t₃ h). After the curing treatment was complete, the resulting mixture was left standing for 1 h, followed by filtration, washing, and drying, to obtain a cured product. The cured product was heated to 750° C. (T₄° C.) at a heating rate of 5° C./min under a nitrogen atmosphere, and then subjected to carbonization treatment at this temperature for 2 h (t₄ h). After the reaction was complete, the product was cooled to room temperature to obtain a carbide.

Step 3: The carbide was mixed with the activator at a mass ratio of 1:2 (w=0.5) and subjected to activation treatment to obtain the porous carbon material, where the activator included potassium hydroxide and sodium carbonate, with a mass ratio of potassium hydroxide to sodium carbonate being 1:0.2; and the activation treatment was performed at a temperature of 700° C. (T₅° C.) for 1 h (t₅ h). After the activation treatment was complete, the material was cooled to room temperature, taken out, washed multiple times with deionized water, neutralized with a small amount of hydrochloric acid to remove impurities, and then dried at 120° C. for 12 h to obtain the porous carbon material.

The compacted density of the porous carbon material in this example under a force of 5000 kgf was 0.53 g/cm³. In the Raman spectrum of the porous carbon material in this example, ID/IG=1.1.

### Preparation of Silicon-Carbon Material

The prepared porous carbon material was placed in a fluidized bed deposition equipment, nitrogen was introduced to fluidize the porous carbon, the temperature was raised at 5° C. per minute to a preset temperature of 500° C., and silane gas was introduced for reaction for 7.5 h. Subsequently, the temperature was raised to 600° C., acetylene gas was introduced to cause generation of a carbon coating layer on the silicon-carbon surface. After the reaction was complete, cooling was performed to reduce the temperature to room temperature to obtain the silicon-carbon material.

### Preparation of Negative Electrode

Graphite, the silicon-carbon material prepared according to the examples and comparative examples, the conductive agent (carbon black), and the binder PAA were mixed at a weight ratio of 70:15:5:10, an appropriate amount of water was added, and kneaded at a solid content of 65 wt %. Then an appropriate amount of water was added to adjust the viscosity of the slurry to 5000 Pa·s to prepare a negative electrode slurry. The prepared negative electrode slurry was applied to the negative electrode current collector copper foil, followed by drying and cold pressing to obtain the negative electrode.

### Preparation of Positive Electrode

LiCoO₂, carbon black, and polyvinylidene fluoride (PVDF) were thoroughly stirred and mixed to uniformity in an N-methylpyrrolidone solvent system at a weight ratio of 95:2.5:2.5 to prepare a positive electrode slurry. The prepared positive electrode slurry was applied to the positive electrode current collector aluminum foil, followed by drying and cold-pressing to obtain the positive electrode.

### Preparation of Electrolyte

In a dry argon environment, LiPF₆ and fluoroethylene carbonate were added to a solvent obtained by mixing propylene carbonate, ethylene carbonate, propyl propionate, and ethyl propionate (at a weight ratio of 2:1:1:2), and mixed to uniformity to obtain the electrolyte, where based on the mass of the electrolyte, the mass percentage of LiPF₆ was 12.5%, and the mass percentage of fluoroethylene carbonate was 3.5%.

### Preparation of Separator

A polyethylene/polypropylene composite porous polymer film with a thickness of 7 μm was used as the separator.

### Preparation of Lithium-Ion Battery

The positive electrode, separator, and negative electrode were stacked in order, with the separator sandwiched between the positive electrode and negative electrode to provide isolation. The resulting stack was wound to obtain a bare cell. The bare cell was placed in an outer packaging, the electrolyte was injected, and the outer packaging was sealed. After processes such as formation, degassing, and trimming were performed, the lithium-ion battery was obtained.

The porous carbon materials of the examples and comparative examples in Table 1 differ from Example 1-1 only in that the preparation method of the porous carbon material was adjusted according to the parameters in Table 1. N1 is potassium hydroxide, N2 is sodium carbonate, and the ratios involved are mass ratios.

TABLE 1

| | | | | | | | Carbide/ | | |
|---|---|---|---|---|---|---|---|---|---|
| | | T₁ | t₁ | T₂ | t₂ | | activator | T₅ | t₅ |
| Number | Phenol:catalyst:aldehyde | (° C.) | (h) | (° C.) | (h) | Activator | w | (° C.) | (h) |
| Example 1-1 | 1:2:2 | 100 | 2 | 150 | 2 | N1:N2(1:0.2) | 0.5 | 700 | 1 |
| Example 1-2 | 1:2:3 | 100 | 2 | 150 | 2 | N1:N2(1:0.2) | 0.5 | 700 | 1 |
| Example 1-3 | 1:2:5 | 100 | 2 | 150 | 2 | N1:N2(1:0.2) | 0.5 | 700 | 1 |
| Example 1-4 | 1:3:5 | 100 | 2 | 150 | 2 | N1:N2(1:0.2) | 0.5 | 700 | 1 |
| Example 1-5 | 1:5:5 | 100 | 2 | 150 | 2 | N1:N2(1:0.2) | 0.5 | 700 | 1 |
| Example 1-6 | 1:5:5 | 80 | 2 | 120 | 2 | N1:N2(1:0.2) | 0.5 | 700 | 1 |
| Example 1-7 | 1:5:5 | 60 | 2 | 90 | 2 | N1:N2(1:0.2) | 0.5 | 700 | 1 |
| Example 1-8 | 1:5:5 | 20 | 6 | 60 | 10 | N1:N2(1:0.2) | 0.5 | 700 | 1 |
| Example 1-9 | 1:3:3 | 60 | 2 | 90 | 2 | N1:N2(1:0.3) | 0.5 | 700 | 1 |
| Example 1-10 | 1:3:3 | 60 | 2 | 90 | 2 | N1:N2(1:0.2) | 0.1 | 700 | 1 |
| Example 1-11 | 1:3:3 | 60 | 2 | 90 | 2 | N1:N2(1:0.2) | 1 | 700 | 1 |
| Example 1-12 | 1:3:3 | 60 | 2 | 90 | 2 | N1:N2(1:0.2) | 0.5 | 621 | 1 |
| Example 1-13 | 1:3:3 | 60 | 2 | 90 | 2 | N1:N2(1:0.3) | 0.5 | 854 | 1 |
| Comparative | 1:3:3 | 60 | 2 | 90 | 2 | N1:N2(1:0.5) | 0.5 | 700 | 1 |
| Example 1-1 | | | | | | | | | |
| Comparative | 1:3:3 | 60 | 2 | 90 | 2 | N1:N2(1:0.2) | 0.5 | 600 | 1 |
| Example 1-2 | | | | | | | | | |
| Comparative | 1:3:3 | 60 | 2 | 90 | 2 | N1 | 0.5 | 700 | 1 |
| Example 1-3 | | | | | | | | | |

The porous carbon materials of the examples and comparative examples in Table 2 differ from Example 1-1 only in that the preparation method of the porous carbon material was adjusted according to the parameters in Table 2.

TABLE 2

| Number | Phenol:stabilizer | T₃ (° C.) | t₃ (h) | T₄ (° C.) | t₄ (h) |
|---|---|---|---|---|---|
| Example 2-1 | 1:2.8 | 60 | 2 | 750 | 2 |
| Example 2-2 | 1:0.1 | 60 | 2 | 750 | 2 |
| Example 2-3 | 1:1.3 | 60 | 2 | 750 | 2 |
| Example 2-4 | 1:1.3 | 50 | 3 | 750 | 2 |
| Example 2-5 | 1:1.3 | 90 | 1 | 750 | 2 |
| Example 2-6 | 1:3 | 60 | 2 | 750 | 2 |
| Example 2-7 | 1:0.8 | 60 | 2 | 1000 | 2 |
| Example 2-8 | 1:0.8 | 60 | 2 | 500 | 2 |
| Example 2-9 | 1:0.8 | 60 | 2 | 450 | 2 |

The porous carbon materials of the examples and comparative examples were tested according to the test methods described above, and the test results are shown in Table 3.

TABLE 3

| | Volume | Volume | | | | | | | | |
|---|---|---|---|---|---|---|---|---|---|---|
| | proportion P₀ | proportion | Specific | Pore | | | Particle | Rate | Cycling | |
| | of ultra- | P₁ of | surface | volume | Compressive | Average | size | capacity | capacity | Thickness |
| | micropores | micropores | area SA | Pv | strength CS | ellipticity | Dᵥ50 | retention | retention | swelling |
| Number | (%) | (%) | (m²/g) | (cm³/g) | (MPa) | ERm | (μm) | rate (%) | rate (%) | rate (%) |
| Example 1-1 | 15 | 95 | 2161 | 1.13 | 1551 | 0.96 | 5.9 | 91.2 | 93.6 | 9.8 |
| Example 1-2 | 21 | 96 | 2396 | 1.02 | 1096 | 0.97 | 5.8 | 88.3 | 91.0 | 10.7 |
| Example 1-3 | 23 | 98 | 2486 | 0.92 | 1158 | 0.96 | 5.7 | 90.2 | 92.6 | 10.3 |
| Example 1-4 | 27 | 99 | 2195 | 0.83 | 1105 | 0.95 | 6.2 | 88.8 | 89.8 | 10.8 |
| Example 1-5 | 21 | 100 | 1967 | 0.77 | 1463 | 0.95 | 6.1 | 91.7 | 94.2 | 10.0 |
| Example 1-6 | 19.5 | 100 | 1940 | 0.76 | 1878 | 0.96 | 5.6 | 92.0 | 95.7 | 9.0 |
| Example 1-7 | 16 | 100 | 1970 | 0.75 | 1823 | 0.97 | 5.6 | 93.9 | 96.4 | 8.7 |
| Example 1-8 | 14 | 100 | 1995 | 0.75 | 1868 | 0.96 | 5.6 | 94.2 | 96.9 | 9.0 |
| Example 1-9 | 6.5 | 96 | 2308 | 1.03 | 1238 | 0.96 | 5.8 | 89.6 | 92.6 | 10.2 |
| Example 1-10 | 5 | 96 | 2347 | 1.02 | 952 | 0.96 | 5.5 | 87.9 | 88.3 | 11.3 |
| Example 1-11 | 2 | 96 | 2393 | 1.01 | 810 | 0.97 | 6.0 | 86.0 | 87.6 | 11.8 |
| Example 1-12 | 28 | 96 | 2318 | 1.04 | 1385 | 0.96 | 5.8 | 88.1 | 88.7 | 11.2 |
| Example 1-13 | 5.8 | 92 | 2035 | 1.20 | 709 | 0.95 | 5.5 | 87.0 | 86.7 | 11.9 |
| Comparative | 5 | 90 | 1551 | 1.45 | 274 | 0.95 | 6.0 | 84.3 | 83.3 | 12.7 |
| Example 1-1 | | | | | | | | | | |
| Comparative | 29 | 100 | 1959 | 0.76 | 1968 | 0.96 | 6.1 | 84.3 | 83.2 | 12.8 |
| Example 1-2 | | | | | | | | | | |
| Comparative | 1 | 91 | 1820 | 1.32 | 150 | 0.96 | 5.9 | 81.1 | 80.9 | 13.9 |
| Example 1-3 | | | | | | | | | | |
| Example 2-1 | 15 | 99 | 2145 | 0.84 | 1634 | 0.95 | 5.2 | 91.5 | 94.2 | 9.7 |
| Example 2-2 | 15 | 98 | 1059 | 0.52 | 1709 | 0.96 | 9.8 | 88.3 | 89.6 | 10.9 |
| Example 2-3 | 18 | 99 | 2019 | 0.85 | 1578 | 0.95 | 6.2 | 92.4 | 95.8 | 9.4 |
| Example 2-4 | 18 | 98 | 1484 | 0.67 | 1683 | 0.95 | 8.1 | 91.9 | 94.9 | 9.4 |
| Example 2-5 | 15 | 99 | 1757 | 0.83 | 1669 | 0.96 | 6.8 | 94.0 | 96.3 | 8.7 |
| Example 2-6 | 14 | 98 | 2672 | 1.6 | 1464 | 0.95 | 1.4 | 90.5 | 92.3 | 10.5 |
| Example 2-7 | 18 | 98 | 1448 | 0.69 | 1651 | 0.94 | 7.5 | 91.5 | 93.7 | 9.6 |
| Example 2-8 | 16 | 99 | 1404 | 0.67 | 1608 | 0.91 | 7.1 | 89.8 | 92.8 | 10.1 |
| Example 2-9 | 17 | 98 | 1462 | 0.65 | 1723 | 0.9 | 7.7 | 88.6 | 91.1 | 10.8 |

From Table 3, it can be seen that this application controls the volume proportion of ultramicropores with a pore diameter less than or equal to 0.7 nm in the porous carbon material to be P₀%, and the volume proportion of micropores with a pore diameter less than or equal to 2 nm to be P₁%, where 2≤P₀≤28 and 92≤P₁≤100, resulting in a highly compact cross-linked structure within the porous carbon material. This can improve the rate performance, expansion suppression performance, and cycling performance of the lithium-ion batteries. In particular, when 6.5≤P₀≤19.5 and 95≤P₁≤100, it is beneficial to enhance the compressive strength and structural stability of the porous carbon material, further improving the rate performance, expansion suppression performance, and cycling performance of the lithium-ion batteries.

Particularly, based on the above micropore structure, the specific surface area of the porous carbon material is controlled to be SA m²/g, where 1059≤SA≤2486, and/or the pore volume of the porous carbon material is controlled to be Pv cm³/g, where 0.52≤Pv≤1.6, resulting in a large specific surface area and abundant micropore structure. This further improves the rate performance, expansion suppression performance, and cycling performance of the lithium-ion batteries.

Particularly, this application further controls the compressive strength CS MPa of the porous carbon material to satisfy 161≤CS≤1968, preferably 1096≤CS≤1878, which, together with the above micropore structure, enables the lithium-ion batteries to exhibit excellent rate performance, expansion suppression performance, and cycling performance.

Particularly, the average ellipticity of the porous carbon material is controlled to be ERm, where 0.91≤ERm≤1, and the particle size Dᵥ50 of the porous carbon material is controlled to be D μm, where 5.2≤D≤9.8, resulting in an appropriate specific surface area and pore volume. This allows lithium-ion batteries to exhibit more significant rate performance, expansion suppression performance, and cycling performance.

Additionally, according to the data from Tables 1 to 3, it can be seen that this application controls the activator to include potassium hydroxide and sodium carbonate, controls the mass ratio of potassium hydroxide to sodium carbonate to 1:(0.1-0.3), and also controls the activation treatment conditions to meet the above ranges. This can enhance the cross-linking degree of the organic precursor and increase the micropore volume proportion of the porous carbon material. As the amount of activator increases, the pore volume of the porous carbon material keeps increasing, while the specific surface area first increases and then decreases. This may be because the proportion of mesopores with pore diameters exceeding 2 nm increases, contributing more pore volume and thus reducing the specific surface area. Moreover, as the activation temperature increases, the pore volume tends to increase, while the specific surface area decreases. This may be because the deeper activation causes more carbon to be etched away, forming more macropores and thus reducing the specific surface area.

In view of this, the mass ratio of the phenolic compound, acidic catalyst, and aldehyde compound is further controlled to be 1:(1-5):(2-5), which, together with gradient heat preservation treatment conditions, results in a highly compact cross-linked structure within the porous carbon material. This improves the specific surface area and pore volume of the porous carbon material, and enhances the compressive strength of the porous carbon material, allowing the lithium-ion batteries to exhibit excellent rate performance, expansion suppression performance, and cycling performance during application. When the catalyst concentration is increased, the particle size Dᵥ50 of the porous carbon material tends to increase, and the compressive strength increases. This is because the increased catalyst concentration accelerates the polymerization and cross-linking reactions, increasing the resin sphere diameter of the organic precursor. Moreover, the increased internal cross-linking degree allows a stable and strong cross-linked network to be formed internally, increasing the strength of the carbon framework. Particularly, this application controls the mass ratio of the carbide to the activator to be w, where 0.1≤w≤1, which can further improve the micropore structure of the porous carbon material, enhancing the above performance of lithium-ion batteries.

Particularly, this application controls the mass ratio of the phenolic compound to the stabilizer to be 1:(0.01-2.8). As the stabilizer concentration increases, the sphere diameter of the porous carbon tends to decrease, so under the same activation conditions, a smaller carbon diameter results in a larger specific surface area and pore volume after activation. Correspondingly, due to the increase in pore volume, the compressive strength of the porous carbon material tends to decrease. Additionally, the curing treatment and carbonization treatment satisfy the above conditions, which further optimizes the micropore structure of the porous carbon material, enables the porous carbon material to have an appropriate particle size distribution, and improves the specific surface area and pore volume of the porous carbon material, allowing lithium-ion batteries to exhibit more excellent rate performance, expansion suppression performance, and cycling performance.

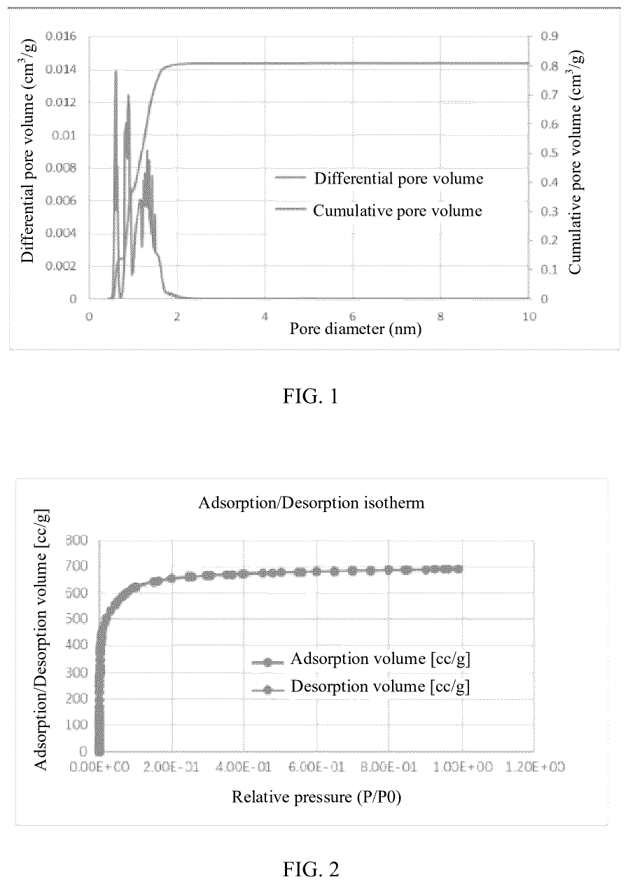

FIG. 1 is a pore distribution diagram of a porous carbon material of Example 1-4, where the volume proportion of micropores with a pore diameter less than or equal to 2 nm, P₁%, is 100%, and the volume proportion of ultramicropores with a pore diameter less than or equal to 0.7 nm, P₀%, is 20%.

FIG. 2 is an adsorption-desorption isotherm diagram of a porous carbon material of Example 1-4. From the adsorption and desorption isotherm data, it can be seen that the adsorption and desorption isotherms almost totally overlap, with a minimal difference between the adsorption volume and the desorption volume, indicating a typical microporous material.

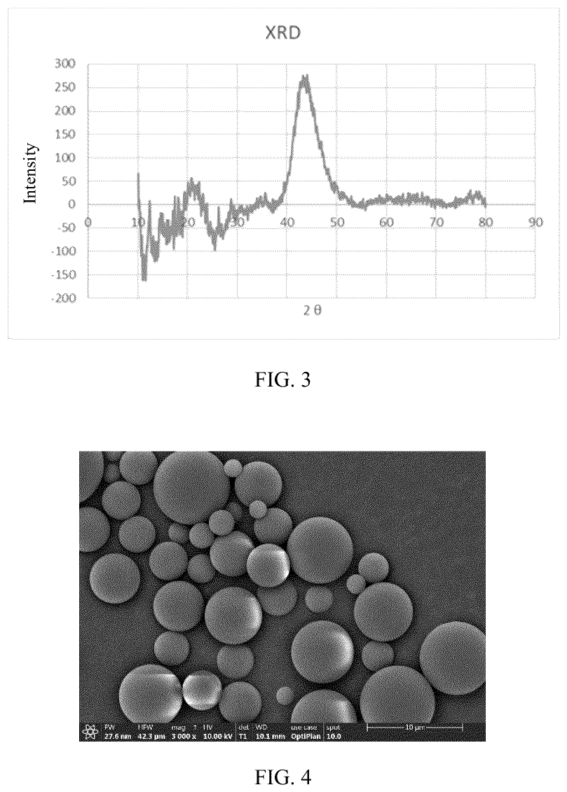

FIG. 3 is an XRD diagram of a porous carbon material of Example 1-4. From the XRD diagram, it can be seen that the porous carbon material of this example exhibits typical amorphous carbon characteristics.

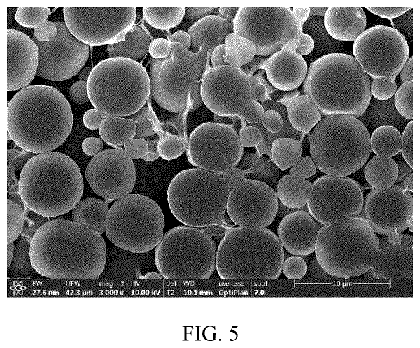

FIG. 4 is an SEM image of a surface morphology of a porous carbon material of Example 1-4, showing that the porous carbon material of this example has a nearly perfect spherical morphology with a relatively high average ellipticity.

FIG. 5 is an SEM image of a cross-sectional morphology of a porous carbon material of Example 1-4, showing that the porous carbon material of this example has a relatively compact internal structure, which is beneficial to enhancing the compressive strength.

The above are only preferred embodiments of this application and are not intended to limit this application. Any modifications, equivalent replacements, and improvements made within the principles of this application should be included within the protection scope of this application.

What is claimed is:

1. A porous carbon material, wherein based on a pore volume of the porous carbon material, a volume proportion of ultramicropores with a pore diameter less than or equal to 0.7 nm is denoted as P₀%, and a volume proportion of micropores with a pore diameter less than or equal to 2 nm is denoted as P₁%, wherein 2≤P₀≤28 and 92≤P₁≤100.

2. The porous carbon material according to claim 1, wherein 6.5≤P₀≤19.5 and 95≤P₁≤100.

3. The porous carbon material according to claim 1, wherein a specific surface area of the porous carbon material is denoted as SA m²/g, wherein 1059≤SA≤2486.

4. The porous carbon material according to claim 1, wherein a pore volume of the porous carbon material is denoted as Pv cm³/g, wherein 0.52≤Pv≤1.6.

5. The porous carbon material according to claim 1, wherein a compressive strength of the porous carbon material is denoted as CS MPa, wherein 161≤CS≤1968.

6. The porous carbon material according to claim 5, wherein 1096≤CS≤1878.

7. The porous carbon material according to claim 1, wherein the porous carbon material satisfies at least one of the following conditions:
(1) an average ellipticity of the porous carbon material is denoted as ERm, wherein 0.91≤ERm≤1;
(2) a compacted density of the porous carbon material under a force of 5000 kgf is denoted as ρ g/cm³, wherein 0.45≤ρ≤0.7; or
(3) in a Raman spectrum of the porous carbon material, 0.8≤ID/IG≤1.5.

8. The porous carbon material according to claim 1, wherein a particle size Dᵥ50 of the porous carbon material is denoted as D μm, wherein 5.2≤D≤9.8.

9. A method of preparation of the porous carbon material according to claim 1, the method comprising following steps:
step 1. subjecting a phenolic compound, an acidic catalyst, a stabilizer, and an aldehyde compound to gradient heat preservation treatment under an inert atmosphere to obtain an organic precursor; wherein
the gradient heat preservation treatment comprises: performing a first heat preservation treatment at a first temperature T₁° C. for a heat preservation duration of t₁ h, and then performing a second heat preservation treatment at a second temperature T₂° C. for a heat preservation duration of t₂ h; wherein 20≤T₁≤100; 0.5≤t₁≤6; 60≤T₂≤150; and 0.5≤t₂≤16; and
a mass ratio of the phenolic compound, the acidic catalyst, and the aldehyde compound is 1:(1-5):(2-5);
step 2. sequentially subjecting the organic precursor to curing treatment and carbonization treatment to obtain a carbide;
step 3. mixing the carbide with an activator, followed by activation treatment to obtain the porous carbon material; wherein
the activator comprises potassium hydroxide and sodium carbonate, a mass ratio of the potassium hydroxide to the sodium carbonate being 1:(0.1-0.3); and
the activation treatment is performed at a temperature T₅° C. for a duration of t₅ h, wherein 621≤T₅≤854; and 0.5≤t₅≤6.

10. The method according to claim 9, wherein the method satisfies at least one of the following conditions:
(1) the phenolic compound comprises at least one of phenol, resorcinol, phloroglucinol, or bisphenol A;
(2) the acidic catalyst comprises at least one of hydrochloric acid, sulfuric acid, nitric acid, or oxalic acid;
(3) the aldehyde compound comprises at least one of formaldehyde, paraformaldehyde, furfural, or acetaldehyde;
(4) the stabilizer comprises at least one of polyvinyl alcohol, polyethylene glycol, hydroxymethyl cellulose, carboxymethyl cellulose, or polyvinylpyrrolidone;
(5) a mass ratio of the phenolic compound to the stabilizer is 1:(0.01-2.8);
(6) the curing treatment is performed at a temperature T₃° C. for a duration of t₃ h, wherein 40≤T₃≤120 and 0.5≤t₃≤6;
(7) the carbonization treatment is performed at a temperature T₄° C. for a duration of t₄ h, wherein 500≤T₄≤1000 and 0.5≤t₄≤6; or
(8) a mass ratio of the carbide to the activator is denoted as w, wherein 0.1≤w≤1.

11. A silicon-carbon material, comprising a porous carbon material, wherein based on a pore volume of the porous carbon material, a volume proportion of ultramicropores with a pore diameter less than or equal to 0.7 nm is denoted as P₀%, and a volume proportion of micropores with a pore diameter less than or equal to 2 nm is denoted as P₁%, wherein 2≤P₀≤28 and 92≤P₁≤100.

12. The silicon-carbon material according to claim 11, wherein 6.5≤P₀≤19.5 and 95≤P₁≤100.

13. The silicon-carbon material according to claim 11, wherein a specific surface area of the porous carbon material is denoted as SA m²/g, wherein 1059≤SA≤2486.

14. The silicon-carbon material according to claim 11, wherein a pore volume of the porous carbon material is denoted as Pv cm³/g, wherein 0.52≤Pv≤1.6.

15. The silicon-carbon material according to claim 11, wherein a compressive strength of the porous carbon material is denoted as CS MPa, wherein 161≤CS≤1968.

16. The silicon-carbon material according to claim 15, wherein 1096≤CS≤1878.

17. The silicon-carbon material according to claim 11, wherein the porous carbon material satisfies at least one of the following conditions:
(1) an average ellipticity of the porous carbon material is denoted as ERm, wherein 0.91≤ERm≤1;
(2) a compacted density of the porous carbon material under a force of 5000 kgf is denoted as ρ g/cm³, wherein 0.45≤ρ≤0.7; or
(3) in a Raman spectrum of the porous carbon material, 0.8≤ID/IG≤1.5.

18. The silicon-carbon material according to claim 11, wherein a particle size Dᵥ50 of the porous carbon material is denoted as D μm, wherein 5.2≤D≤9.8.

19. The silicon-carbon material according to claim 11, wherein the porous carbon material prepared using the preparation method according to claim 9.

20. The silicon-carbon material according to claim 11, wherein the porous carbon material prepared using the preparation method according to claim 10.
